(19) United States
(12) Patent Application Publication
(10) Pub. No.: US 2006/0038443 A1
(43) Pub. Date: Feb. 23, 2006

(54) Surface vehicle wheel anti-skid system

(76) Inventor: James E. Stewart, Redding, CA (US)

Correspondence Address: JAMES E. STEWART, 251 HILLTOP #80, REDDING, CA, 96003, US

(21) Appl. No.: 10/922,309

(22) Filed: Aug. 20, 2004

(51) Int. Cl. B60T 8/88

(52) U.S. Cl. 303/148

(57) ABSTRACT

An anti-skid braking system using a mass acceleration sensor to control the amount of hydraulic pressure applied to the wheel cylinders. In this application the accelerometer is used to sense a decrease in velocity only. The system can be used on any vehicle traversing any surface. For any vehicle tire/wheel combination there is a given foot print, (area of contact between the tire and road surface}. The foot print will dictate a maximum coefficient of friction for a given tire/pressure combination. The deceleration sensed by the accelerometer is used to limit the hydraulic pressure applied to the brake cylinders at a pressure less than would be required to reach the maximum coefficient of friction limit. Under cold/wet/ice conditions, snow, ice, or water of a depth to cause hydroplaning, this system will allow the wheels to be locked. Most Auto braking systems would cycle the wheel between locked and free wheeling.

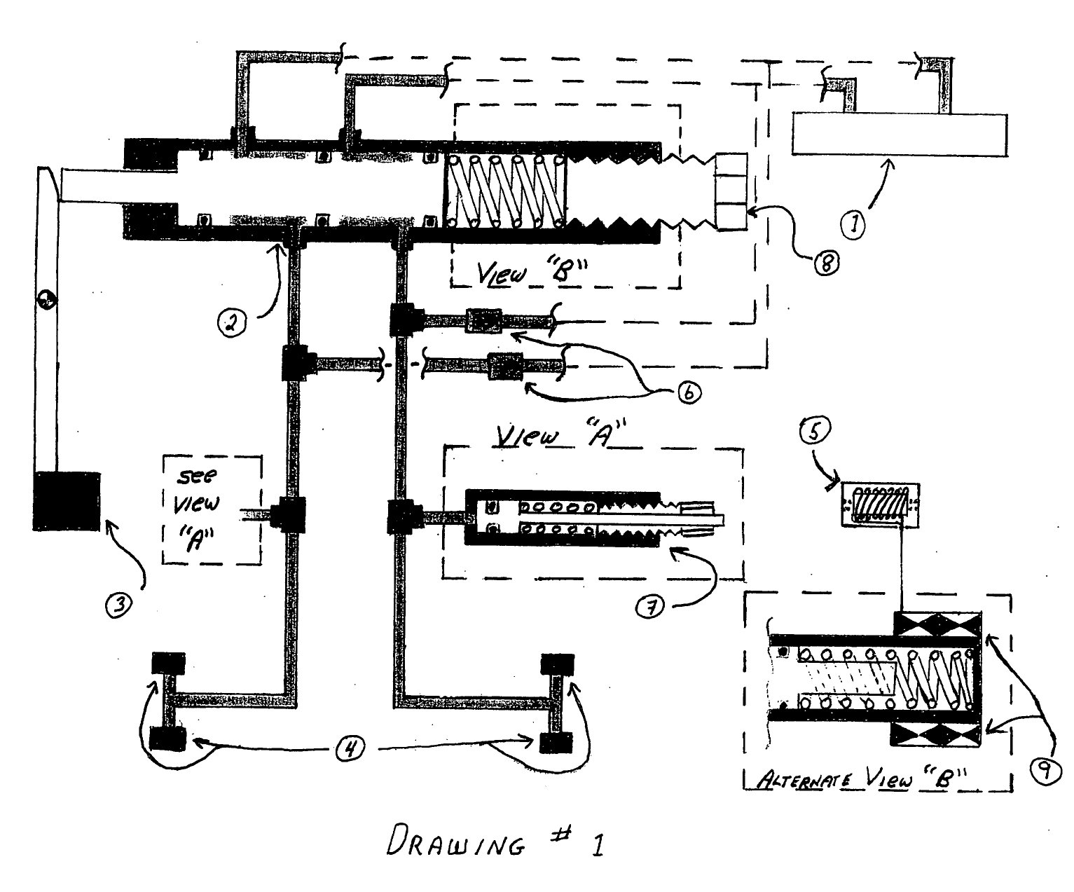

This anti skid braking system uses a mass acceleration sensor to control the amount of hydraulic pressure applied to the wheel cylinders. In general an accelerometer will sense any change in velocity. In this application the accelerometer is used to sense a decrease in velocity only. The system Can be used in any vehicle traversing any surface, however it's optimum performance is on vehicles with pneumatic tires on a wet/dry hard surface road, i.e. asphalt or concrete. For any vehicle tire combination there is a given given foot print, (area of contact between the tire and road surface upon which it rest). The foot print will dictate a maximum coefficient of friction for a given vehicle tire combination. The deceleration sensed by the accelerometer is used to limit the hydraulic pressure applied to the brake cylinders at a lower pressure than would be required to reach or exceed the maximum coefficient of friction limit, i.e. ideally 85% to 95% of the maximum coefficient of friction. Under cold/wet/ice surface conditions, i.e. snow, ice or water of a depth to cause hydro-planing, this system will allow the wheels to be locked, “in a skid”. Most ABS (automatic braking systems) would cycle the wheels between locked and free wheeling. Which would be more desirable is debatable.

DRAWING # 1

1 Hydraulic master/power cylinder. Supplies hydraulic pressure to the system—typical.

2 A dual spool type hydraulic fluid flow control valve for routing through and/or blocking hydraulic pressure within the system.

3 Mechanical application. A weighted and fulcrumed lever, which upon sensing the pre-set deceleration rate for the vehicle will maintain the optimum hydraulic pressure to the wheel cylinders until the vehicle stops or the vehicle operator terminates the braking action.

4 Wheel brake cylinders—typical.

5 & 9—5 Alternate control system, 5 Electronic accelerometer—When set to sense the optimum deceleration rate will generate an electrical signal which in conjunction with, (9) the electro magnetic actuator will preform the same function as the mechanical accelerometer.

6 One way check valves—as long as hydraulic pressure is being applied from the master/power cylinder the valves will be closed. When the vehicle operator terminates the braking action the valves will open, relieving pressure in the system and route the fluid back to the system reservoir.

7 Oil/spring accumulators—Stores hydraulic fluid under pressure and maintains this pressure to the wheel brake cylinders when the accelerometer has completely closed the hydraulic flow control valve.

8 Set screw—Used to set spring tension that will allow the accelerometer to close the hydraulic flow control valve when the optimum deceleration rate is reached. Used with mechanical application only.

1. An anti skid system that can provide the optimum stopping distance for wheeled vehicles.
Features
1 Simplicity
2 Cost to manufacture
3 Cost to maintain
4 Fail safe design—i.e. Should the accelerometers fail to function, the system would be in manual operation mode.
